(19) United States
(12) Patent Application Publication
(10) Pub. No.: US 2019/0244536 A1
(43) Pub. Date: Aug. 8, 2019

(54) INTELLIGENT TACTICAL ENGAGEMENT TRAINER

(71) Applicant: ST ELECTRONICS (TRAINING & SIMULATION SYSTEMS) PTE. LTD., Singapore (SG)

(72) Inventors: Chuan Huat TAN, Singapore (SG); Chee Kwang QUAH, Singapore (SG); Tik Bin OON, Singapore (SG); Wui Siong KOH, Singapore (SG)

(73) Assignee: St Electronics (Training & Simulation Systems) Pte. Ltd., Singapore (SG)

(21) Appl. No.: 16/317,542

(22) PCT Filed: Jan. 5, 2017
(86) PCT No.: PCT/SG2017/050006

§ 371 Date: Jan. 12, 2019

(30) Foreign Application Priority Data
Jul. 12, 2016 (SG) 10201605705P

(51) Int. Cl. G09B 9/00; F41J 5/08; F41G 3/26; F41A 33/02; F41J 9/02; B25J 11/00

(52) U.S. Cl. CPC G09B 9/003; F41J 5/08; B25J 11/002; F41A 33/02; F41J 9/02; F41G 3/2655

(57) ABSTRACT

There is provided a simulation-based Computer Generated Force (CGF) system for tactical training in a training field including a receiver for receiving information on the training field, a database for storing a library of CGF behaviours for one or more robots in the training field, a CGF module, coupled with the receiver and the database, for processing the information on the training field and selecting a behaviour for each of the one or more robots in the training field from the library of CGF behaviours stored in the database, a controller, coupled with the CGF module, for sending commands based on the selected behaviours to the one or more robots in the training field. The information on the training field includes location of one or more trainees and the commands include shooting the one or more trainees.

### FIELD OF THE INVENTION

The present invention relates to the field of autonomous robots. In particular, it relates to an intelligent tactical engagement trainer.

### BACKGROUND

Combat personnel undergo training where human players spar with the trainers or an opposing force (OPFOR) to practice a desired tactical response (e.g. take cover and fire back). In the tactical and shooting practices, a trainer or OPFOR could be replaced by an autonomous robot. The robot has the advantages that it does not have fatigue and emotional factors; however, it must have intelligent movement and reactions such as shooting-back in an uncontrolled environment i.e. it could be a robotic trainer acting as an intelligent target that reacts to the trainees. Conventionally, systems have human look-a-like targets that are mounted and run on fixed rails giving it fixed motion effects. In another example, mobile robots act as targets that operate in a live firing range setting. However, shoot-back capabilities in such systems are not defined. In yet another example, a basic shoot back system is provided. However, the system lacks mobility, intelligence and does not address human-like behaviours in the response. Conventionally, a barrage array of laser is used without any aiming.

### SUMMARY OF INVENTION

In accordance with a first aspect of an embodiment, there is provided a simulation-based Computer Generated Force (CGF) system for tactical training in a training field including a receiver for receiving information on the training field, a database for storing a library of CGF behaviours for one or more robots in the training field, a CGF module, coupled with the receiver and the database, for processing the information on the training field and selecting a behaviour for each of the one or more robots in the training field from the library of CGF behaviours stored in the database, a controller, coupled with the CGF module, for sending commands based on the selected behaviours to the one or more robots in the training field. The information on the training field includes location of one or more trainees and the commands include shooting the one or more trainees.

In accordance with a second aspect of an embodiment, there is provided a method for conducting tactical training in a training field, including receiving information on the training field, processing the information on the training field, selecting a behaviour for each of one or more robots in the training field from a library of CGF behaviours stored in a database, and sending commands based on the selected behaviours to the one or more robots in the training field. The information on the training field includes location of one or more trainees and the commands include shooting the one or more trainees.

### BRIEF DESCRIPTION OF DRAWINGS

The accompanying figures, serve to illustrate various embodiments and embodiments and to explain various principles and advantages in accordance with a present embodiment.

FIG. 1 depicts an exemplary system of the present embodiment.

FIG. 2 depicts exemplary robot shoot-back architecture of the present embodiment.

FIG. 3 depicts an overview of robotic shoot-back CGF system of the present embodiment.

FIG. 4 depicts an exemplary target engagement scenario of the present embodiment.

FIG. 5 depicts an exemplary functional activity flow of automatic target engagement system from the shooter side in accordance with present embodiment.

FIG. 6 depicts an exemplary method of adjusting focus to tracking bounding box of the human target in accordance with present embodiment.

FIG. 7 depicts an exemplary system robot shoot-back system in accordance with present embodiment.

FIG. 8 depicts a flowchart of a method for conducting tactical training in a training field in accordance with present embodiment.

FIG. 9 depicts a flowchart of engaging target using computer vision in accordance with present embodiment.

Skilled artisans will appreciate that elements in the figures are illustrated for simplicity and clarity and have not necessarily been depicted to scale. For example, the dimensions of some of the elements in the block diagrams or flowcharts may be exaggerated in respect of other elements to help to improve understanding of the present embodiments.

### DETAILED DESCRIPTION

In accordance with an embodiment, there is provided a robot solution that would act as a trainer/OPFOR, with which players can practice tactical manoeuvers and target engagements.

In accordance with an embodiment, there is provided a simulation system backend that provides the scenario and behaviours for the robotic platform and its payload. The robotic platform carries a computer vision-based shoot-back system for tactical and target engagement using a laser engagement system (e.g. MILES2000).

These embodiments advantageously enable at least to:
(i) resolve the issues related to operating in an uncontrolled environment whereby structure of the scene is not always known beforehand, and
(ii) bring about better representative target engagement experience to the trainees at different skill levels, i.e. The shoot-back system can be programmed for different levels of response (e.g. from novice to expert levels).

These solutions are versatile such that they could be easily reconfigured onto different robot bases such as wheeled, legged or flying. In particular, a collective realization of the following features is advantageously provided:

(1) Simulation-based computer generated force (CGF) behaviours and actions as a controller for the robotic shoot back platform.
(2) A computer vision-based intelligent laser engagement shoot-back system.
(3) A voice procedure processing and translation system for two-way voice interaction between instructors/trainees and the robotic shoot-back platform.

### Robot System (Autonomous Platform)

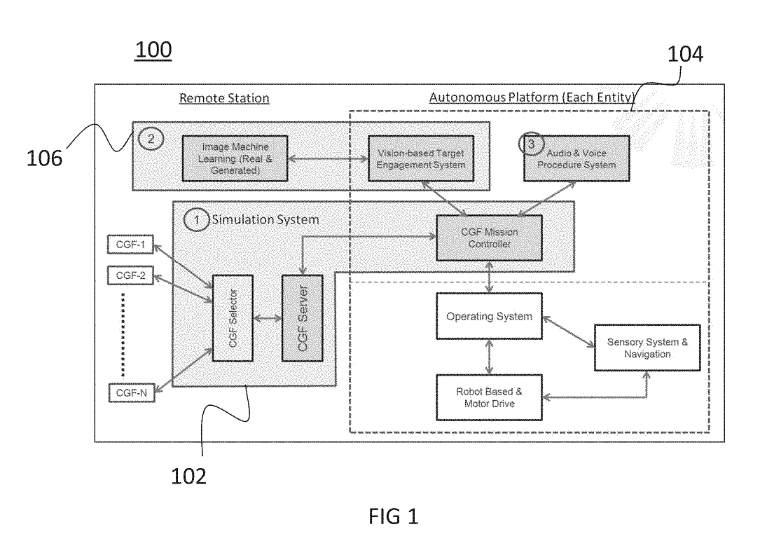

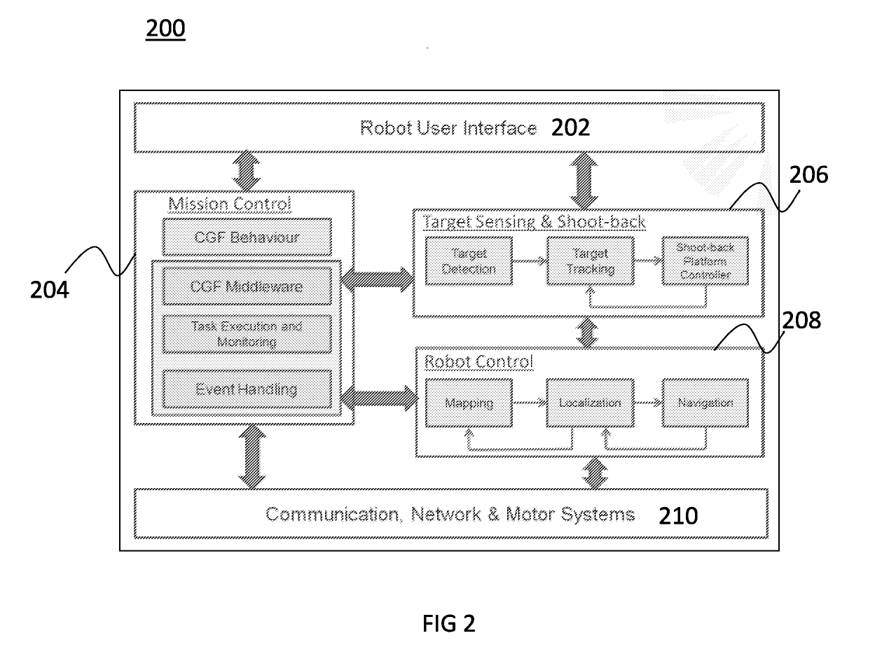

FIG. 1 shows an overview of the system of the present embodiment. The system 100 includes a remote station and one or more autonomous platform 104. On the other hand, FIG. 2 shows an exemplary architecture of the system 200 of the present embodiment. The system 200 includes a robot user interface 202, a mission control part 204, a target sensing and a shoot back part 206, a robot control part 208, and a communication, network and motor system 210. The system 200 comprises a set of hardware devices executing their respective algorithms and hosting the system data.

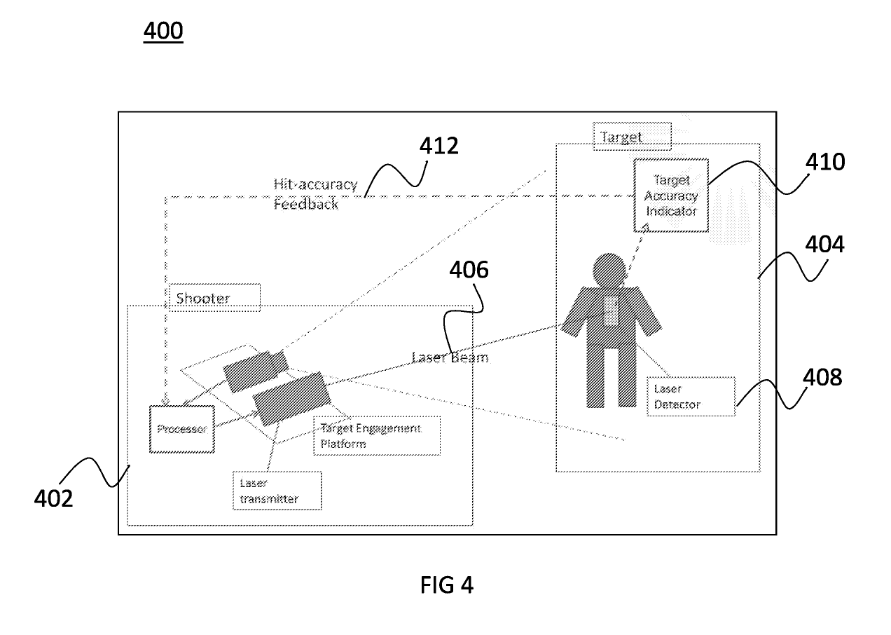

The target sensing and shoot back part 206 in each of one or more autonomous platforms 104 includes optical-based electromagnetic transmitter and receiver, camera(s) ranging from infra-red to colour spectral, sensors for range, imaging depth sensors and sound detectors. The optical-based electromagnetic transmitter and receiver may function as a laser engagement transmitter and detector which is further discussed with reference to FIG. 4. The camera ranging from infra-red to colour spectral, the sensor for range, and the imaging depth sensor may include a day camera, IR camera or thermal imagers, LIDAR, or RADAR. These cameras and sensors may function as the computer vision inputs. The target sensing and shoot back part 206 further includes a microphone for detecting sound. In addition to audible sound, ultrasound or sound with other frequency ranges may be also detected by the microphone. To stabilize the position of devices, gimbals and/or pan-tilt motorized platforms may be provided in the target sensing and shoot back part 206.

The one or more autonomous platforms 104 further include computing processors coupled to the optical based electromagnetic transmitter and receiver, cameras, and sensors for executing their respective algorithms and hosting the system data. The processors may be embedded processors, CPUs, GPUs, etc.

The one or more autonomous platforms 104 further include communication and networking devices 210 such as WIFI, 4G/LTE, RF radios, etc. These communication and networking devices 210 are arranged to work with the computing processors.

The one or more autonomous platforms 104 could be legged, wheeled, aerial, underwater, surface craft, or in any transport vehicle form so that the one or more autonomous platforms 104 can move around regardless of conditions on the ground.

The appearance of the one or more autonomous platforms 104 is configurable as an adversary opposing force (OPFOR) or as a non-participant (e.g. civilian). Depending on the situation to be used, the one or more autonomous platforms 104 are flexibly configured to fit each situation.

The target sensing and shoot back part 206 may include paint-ball, blank cartridges or laser pointers to enhance effectiveness of training. Also, the target sensing and shoot-back part 206 can be applied to military and police training as well as sports and entertainment.

In an embodiment, an image machine learning part in a remote station may work with the vision-based target engagement system 206 in the autonomous platform 104 for enhancing the target engagement function as shown in 106 of FIG. 1.

### Simulation System

Also, a Simulation System 102 of FIG. 1 through its Computer Generated Force (CGF) provides the intelligence to the system 100 to enable the training to be done according to planned scenarios and intelligent behaviours of the robotic entities (shoot-back robotic platform) 104.

The modules of a standard CGF rational/cognitive model cannot be directly controlling a robot with sensing and control feedback from the robot as these high-level behavioural models do not necessarily translate into robotic actions/movements and vice versa. Conventionally, this in-direct relationship is a key obstructive factor that makes the direct integration of modules challenging. As such it was tedious to design the training scenarios for a robot's autonomous actions as part of the training scenarios in a conventional system.

In accordance with present embodiment, the pre-recorded path of the actual robot under remote control is used to set up a training scenario. Furthermore, in contrast to the tedious set up issues highlighted previously, the computer is used via a 3D game engine to bring about a more intuitive method for designing the robot movements.

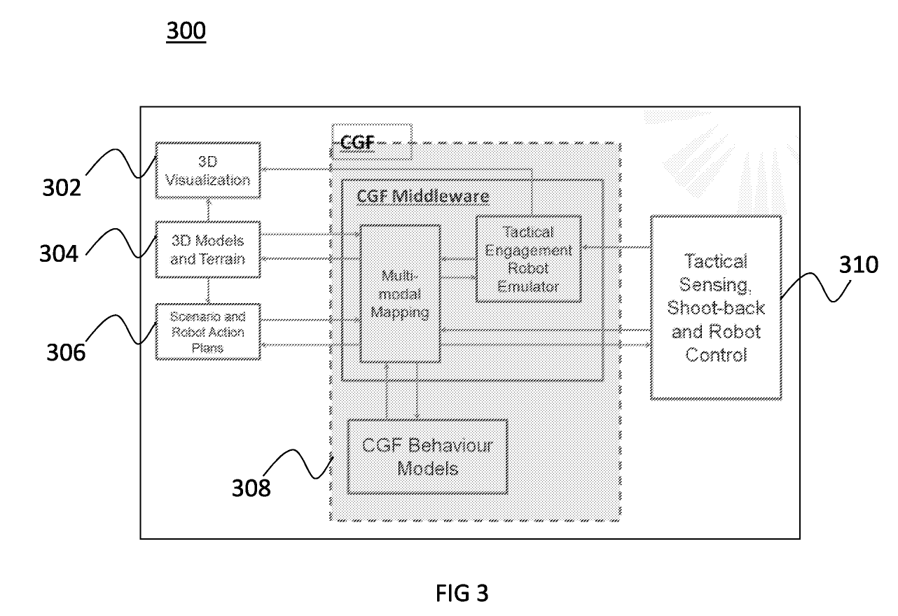

In accordance with an embodiment, a CGF middleware (M-CGF) that is integrated into a standard CGF behavioural model is provided as shown in 204 of FIG. 2. The CGF is used as the intelligent module for this tactical engagement robot. FIG. 3 shows an overview of the robotic CGF system. Through the M-CGF, it processes the multi-variable and multi-modal inputs of a high-level behaviour and robot actions into a meaningful real-time signal to command the shoot-back robot.

The functionalities and components of this simulation system include CGF middleware. CGF middleware 308 inputs 3D action parameters of robots, planned mission parameters, CGF behaviours and robot-specific dynamic parameters such as maximum velocity, acceleration, payload, etc.

The CGF middleware 308 processes the multi-variable and multi-modal inputs (both discrete and continuous data in the spatial temporal domain) into a meaningful real-time signal to command the robot. Atomic real-time signals are commanding the robot emulator for visualization in the graphics engine.

In the CGF middleware 308, a robot emulator is used for virtual synthesis of the shoot-back robot for visualization. Also the CGF middleware 308 could be in the form of a software application or dedicated hardware such as a FPGA.

The simulation system further includes Computer Generated Force (CGF) cognitive components. In the CGF cognitive components, robotic behaviours are designed like CGF behaviours and may be residing on the robot, on the remote server or on both.

The CGF behaviours imaged onto the robotic platform can drive the robotic actions directly and thus result in desired autonomous behaviours to enable the training outcomes as planned.

In the CGF cognitive components, machine learning is used to adjust and refine the behaviours. Also, the CGF cognitive components use information on simulation entities and weapon models to refine the CGF behaviours.

Furthermore, the CGF cognitive components enable the robot (autonomous platform) to interact with other robots for collaborative behaviours such as training for military operations.

The CGF cognitive components also enable the robot to interact with humans, such as trainers and trainees. The components generate action-related voice procedures and behaviour-related voice procedures preferably in multi-languages so that it gives instruction to the trainees. The components also include voice recognition components so that the robot receives and processes instructions from the trainers.

The simulation system further includes a terrain database 304. The data obtained from the terrain database 304 enables 3D visualization of the field which refines autonomous behaviours.

Based on computer vision algorithms, the simulation system generates data sets of virtual image data for machine learning. The data sets of virtual image data are refined through machine learning.

The system further includes a library of CGF behaviours. One or more CGF behaviours are selected in the library of CGF behaviours based on training objectives.

In the simulation system, a pedagogical engine automatically selects behaviours and difficulty levels based on actions of trainees detected by computer vision. For example, if trainees are not able to engage robotic targets well, the robotic targets detect the poor trainee actions. In response, the robotic targets determined to lower the difficulty level from expert to novice. Alternatively, the robotic targets can change behaviours, such as slowing down movements to make the training more progressive.

Gestures by humans are mapped to commands with feedback control such as haptic feedback or tactile feedback. In the simulation system, the gestures by humans are trained to enhance their preciseness. Gesture control for single or multiple robot entities is carried out in the simulation system. If the gesture control in the simulation system is successful, it is mirrored onto the robot's mission controller.

### Mission Controller

The mission controller 204 in the shoot back robot may execute computer implemented methods that manage all the functionality in the shoot back robot and interface with the remote system. For example, the mission controller 204 can receive scenario plans from the remote system. The mission controller 204 can also manage behaviour models.

The mission controller 204 further disseminates tasks to other modules and monitors the disseminated tasks.

Furthermore, the mission controller 204 manages coordination between the shoot back robots for collaborative behaviours such as training for military operations.

During the training, several data such as robot behaviours, actions and navigations are recorded and compressed in accordance with an appropriate format.

### Target Sensing and Engagement

For a robotic shoot back system, a robot needs to see and track a target (a trainee) in line-of-sight with a weapon before the target (the trainee) hits the robot. After a robot shoots at a target, it needs to know how accurately it hits the target. Also in any system, the target sensing and shooting modules have to be aligned.

FIG. 4 shows an overview of an exemplary computer vision-based target engagement system 400. The system enables a shooter (such as a robotic platform) 402 to engage a distant target (such as a trainee) 404.

The shooter 402 includes a target engagement platform, a processor and a laser transmitter. The target engagement platform detects a target 404 by a camera with computer vision functions and tracks the target 404. The target engagement platform is coupled to the processor which executes a computer implemented method for receiving information from the target engagement platform. The processor is further coupled to the laser transmitter, preferably together with an alignment system. The processor further executes a computer implemented method for sending instruction to the laser transmitter to emit a laser beam 406 with a specific power output in a specific direction.

The target 404 includes a laser detector 408 and a target accuracy indicator 410. The laser detector 408 receives the laser beam 406 and identifies the location where the laser beam reaches on the target 404. The distance between a point where the laser beam 406 is supposed to reach and the point where the laser beam 406 actually reaches is measured by the target accuracy indicator 410. The target accuracy indicator 410 sends hit accuracy feedback 412 including the measured distance to the processor in the shooter 402. In an embodiment, the target accuracy indicator 410 instantaneously provides hit-accuracy feedback 412 to the shooter in the form of coded RF signals. The target accuracy indicator 410 may provide hit-accuracy feedback 412 in the form of visual indicators. The processor in the shooter 402 may receive commands from the CGF in response to the hit-accuracy feedback 412.

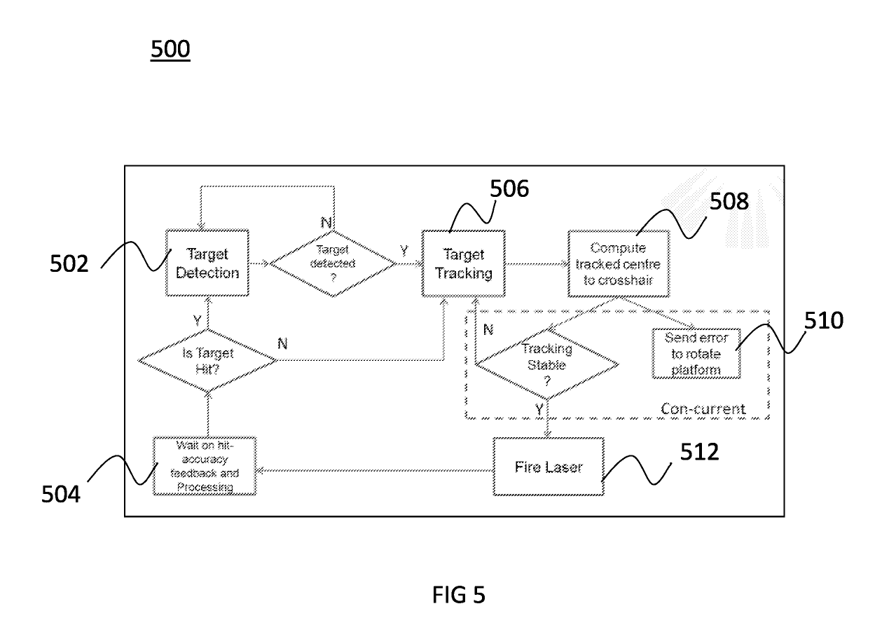

FIG. 5 shows a functional activity flow 500 of the automatic target engagement system. The functional activity flow 500 at different stages includes the various actions and events such as rotating platform 510, when to start and stop firing a laser 512, when to restart target detection, and with other concurrent functions.

On the shooter side, at least one camera and laser beam transmitter is mounted on the rotational target engagement platform. Also the camera and transmitter may be rotated independently. If the target is detected in 502, the functional activity flow moves forward to target tracking 506. The target detection and tracking are carried out by the computer vision-based methods hosted on the processor.

In 508, the position difference between the bounding box of the tracked target and the crosshair is used for rotating the platform 510 until the bounding-box centre and the crosshair are aligned. Once the tracking is considered stable, the laser is triggered in 512.

On the target side, upon detection of a laser beam/cone, the target would produce a hit-accuracy feedback signal through (i) a visual means (blinking light) or (ii) a coded and modulated signal of RF media which the “shooter” is tuned to.

The shooter waits for the hit-accuracy feedback from the target side in 504. Upon receiving the hit-accuracy feedback, the system decides whether to continue with the same target.

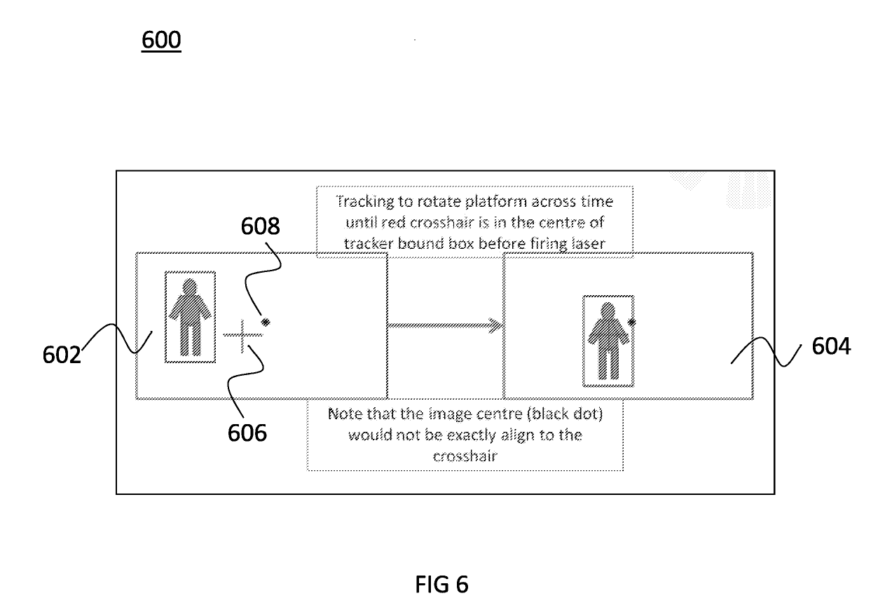

FIG. 6 illustrates tracking of the target and the laser firing criterion 600. The image centre 608 may not be exactly aligned to the crosshair 606 and the pixel position offset between the crosshair 606 and the black dot 608 compensate for the difference in location and orientation when mounted onto the platform (see FIG. 4). The computing for this pixel offset is done through a similar setup as in FIG. 4.

In 602, target is not aligned to the crosshair 606. Thus, the platform is rotated until the crosshair 606 is in the centre of a tracker bound box before firing the laser as shown in 604.

In one example, a system for automatic computer vision-based detection and tracking of targets (human, vehicles, etc) is provided. By using adaptive cone of laser ray shooting based on image tracking, the system specially aligns aiming of the laser shoot-back transmitter to enhance preciseness of the tracking of the targets.

Use of computer vision resolves the issues of unknown or lack of precision in location of the target, and target occlusion in uncontrolled scenes. Without the computer vision, detecting and tracking of the target may not be successful.

In an example, the computer vision algorithm is assisted by an algorithm with information from geo-location and geo-database. Also, the computer vision may include single or multiple-camera(s), or multiple views or a 360 view.

The system includes target engagement laser(s)/transmitter(s), and detector(s). The system further includes range and depth sensing such as LIDAR, RADAR, ultrasound, etc.

The target engagement lasers will have self-correction for misalignment through computer vision methods. For example, the self-correction function is for fine adjustment to coarse physical mounting. Further, an adaptive cone of fire laser shooting could also be used for alignment and zeroing.

As a mode of operation, live image data is collected and appended to its own image database for future training of a detection and tracking algorithm.

In an example, robots share information such as imaging and target data which may contribute to collective intelligence for the robots.

### Audio and Voice System

In an example, a combat voice procedure may be automatically generated during target engagement. The target engagement is translated into audio for local communication and modulation transmission.

Furthermore, the audio and voice system receives and interprets demodulated radio signals from human teammates so that they facilitate interaction with human teammates. In addition, the system may react to collaborating humans and/or robots in audible voice output through a speaker system or through the radio communication system. The system will also output the corresponding weapon audible effects.

### Others: Robot Control, Planner, Communication, Network and Motor System

In addition to the above discussed features, the system may have adversary mission-based mapping, localization and navigation, with real-time sharing and updating of mapping data among collaborative robots. Furthermore, distributed planning functionalities may be provided in the system.

Also, power systems may be provided in the system. The system may be powered by battery systems, or other forms of state of the art power systems, e.g. hybrid, solar systems etc. The system will have a return home mode when the power level becomes low (relative to the home charging location).

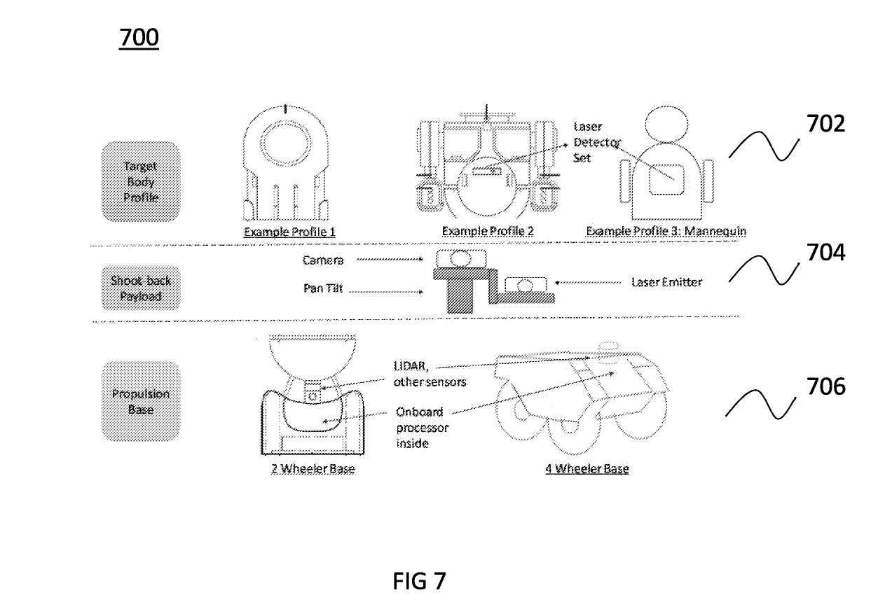

FIG. 7 shows exemplary profiles of several robotic platforms 700. An exemplary target body profile 702 includes example profile 1, example profile 2 and example profile 3. Example profile 1 includes basic components for the target body while example profile 2 and example profile 3 include laser detector sets to enhance the detection of lasers. Also, the example profile 3 is a Mannequin shaped figure to enhance the training experience. By using the Mannequin shaped target having a similar size to humans, a trainee can feel as if he/she is in a real situation.

An exemplary shoot-back payload is shown as 704. The shoot-back payload includes a camera and a pan tilt actuator and a laser emitter. Data detected by the camera actuates the pan tilt actuator to align the laser emitter so that the laser beam emitted by the laser emitter precisely hits the target.

Exemplary propulsion bases are shown as 706. The exemplary propulsion bases include 2 wheeler bases and 4 wheeler bases. Both of the 2 wheeler bases and the 4 wheeler bases have LIDAR and other sensors. Also, on-board processors are embedded.

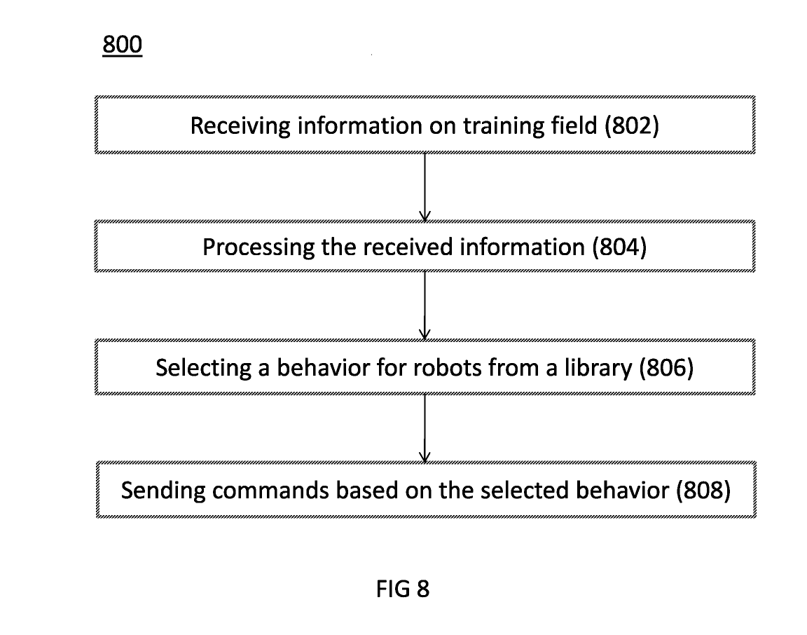

FIG. 8 depicts a flowchart 800 of a method for conducting tactical training in a training field in accordance with the present embodiment. The method includes steps of receiving information on the training field (802), processing the received information (804), selecting behaviour for robots from a library (806) and sending commands based on the selected behaviour (808).

Information on the training field received in step 802 includes location information of one or more robots in the training field. The information on the training field also includes terrain information of the training field so that one or more robots can move around without any trouble. The information further includes location information of trainees so that the behaviour of each of the one or more robots is determined in view of the location information of the trainees.

In step 804, the received information is processed so that behaviour for each of the one or more robots is selected based on the results of the process.

In step 806, behaviour for each of the one or more robots in the training field is selected from a library of CGF behaviours stored in a database. The selection of behaviour may include selection of collaborative behaviour with other robots and/or with one or more trainees so that the one or more robots can conduct organizational behaviours. The selection of behaviour may also include communicating in audible voice output through a speaker system or through a radio communication system.

The selection of behaviour may further include not only outputting voice through the speaker but also inputting voice through a microphone for the communication.

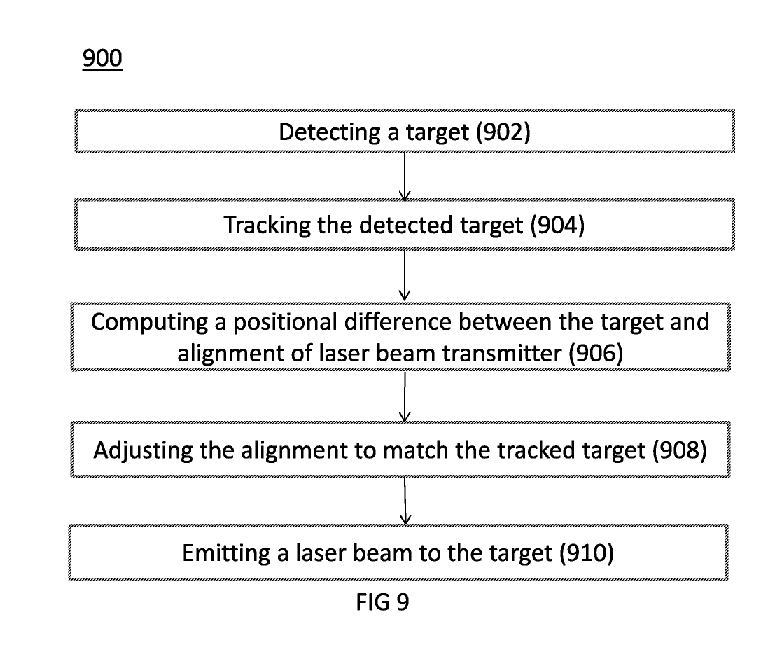

FIG. 9 depicts a flowchart 900 of engaging a target using computer vision in accordance with the present embodiment. The method includes steps of detecting a target (902), tracking the detected target (904), computing a positional difference between the target and an alignment of the laser beam transmitter (906), adjusting the alignment to match the tracked target (908), and emitting a laser beam towards the target (910).

In accordance with an embodiment, the method 900 further includes receiving a feedback with regard to accuracy of the laser beam emission from the laser beam transmitter.

In step 902, the detecting includes range and depth sensing including any one of LIDAR and RADAR for precisely locating the target.

In step 906, the computing includes computing a positional difference of geo-location information in a geo-database.

In step 908, the adjusting the alignment includes rotating a platform of the laser beam transmitter.

In summary the present invention provides a robot solution that would act as a trainer/OPFOR with which players can practice tactical manoeuvres and target engagement.

In contrast to conventional systems which lack mobility, intelligence and human-like behaviours, the present invention provides simulation based computer generated force (CGF) behaviours and actions as controller for the robotic shoot back platform.

In particular, the present invention provides a computer vision based intelligent laser engagement shoot-back system which brings about a more robust representative target engagement experience to the trainees at different skill levels.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A simulation-based Computer Generated Force (CGF) system for tactical training in
a training field comprising:
a receiver that receives information on the training field;
a database that stores a library of CGF behaviours for one or more robots in the training field;
computer vision including one or more cameras and sensors on the one or more robots that sense one or more trainees and movement of the one or more trainees during training on the training field;
a CGF module, coupled with the receiver and the database, that processes the information on the training field and selects a behaviour for each of the one or more robots in the training field from the library of CGF behaviours stored in the database;
a controller, coupled with the CGF module, including CGF middleware (M-CGF) that processes multi-variable and multi-nodal inputs of robot actions into real-time commands that command the one or more robots and that are based on the selected behaviours to the one or more robots in the training field; and
wherein the information on the training field includes location of the one or more trainees and the commands include shooting the one or more trainees.

2. The simulation-based CGF system in accordance with claim 1 further comprising:
a pedagogical engine that automatically changes behaviours of the one or more robots and difficulty levels for the trainees based on actions of the trainees detected by the computer vision during the training on the training field.

3. The simulation-based CFG system in accordance with claim 2, wherein the pedagogical engine changes the behaviours of the one or more robots that include slowing down movements of the one or more robots during the training to lower a difficulty level for the one or more trainees in the training field.

4. The simulation-based CGF system in accordance with claim 1, wherein the behaviour for each of the one or more robots in the training field comprises collaborative behaviours with other robots so that the one or more robots can conduct organizational behaviours.

5. The simulation-based CGF system in accordance with claim 1, wherein the behaviour for each of the one or more robots in the training field comprises collaborative behaviours with the one or more trainees so that the one or more robots can conduct organizational behaviour with the one or more trainees.

6. The simulation-based CGF system in accordance with claim 1, wherein the controller receives scenario plans from a remote system disseminates tasks to the CGF module, and manages coordination between a plurality of the one or more robots for collaborative behaviours between the plurality of the one or more robots during training on the training field.

7. The simulation-based CGF system in accordance with claim 1, wherein the information received by the receiver comprises one or more of the following inputs: (i) 3D action parameters of robot, (ii) planned mission parameters, (iii) CGF behaviours and (iv) robot-specific dynamic parameters including max velocity, acceleration and payload.

8. The simulation-based CGF system in accordance with claim 1, wherein the commands are provided to different robot types that include wheeled robots and legged robots.

9. The simulation-based CGF system in accordance with claim 1, wherein the database is comprised in a remote server.

10. The simulation-based CGF system in accordance with claim 1, wherein the behaviour refinement module is configured to generate datasets of virtual image data for machine learning based computer vision algorithm to adjust and refine the behaviours.

11. The simulation-based CGF system in accordance with claim 1, wherein the library of CGF behaviours stored in the database comprises simulation entities and weapon models.

12. A simulation-based Computer Generated Force (CGF) system for tactical training in a training field comprising:
a receiver that receives information on the training field;
a database that stores a library of CGF behaviours for one or more robots in the training field;
computer vision including one or more cameras and sensors on the one or more robots that sense one or more trainees and movement of the one or more trainees during training on the training field;
a CGF module, coupled with the receiver and the database, that processes the information on the training field and selects a behaviour for each of the one or more robots in the training field from the library of CGF behaviours stored in the database;
a controller, coupled with the CGF module, that sends commands based on the selected behaviours to the one or more robots in the training field; and
a pedagogical engine that automatically changes behaviours of the one or more robots and difficulty levels for the trainees based on actions of the trainees detected by the computer vision during the training on the training field,
wherein the information on the training field includes location of the one or more trainees and the commands include shooting the one or more trainees.

13. The simulation-based CGF system in accordance with claim 12, wherein the pedagogical engine changes the behaviours of the one or more robots that include maximum velocity and acceleration of the one or more robots during the training to change a difficulty level for the one or more trainees in the training field.

14. The simulation-based CGF system in accordance with claim 12, wherein the controller includes CGF middleware (M-CGF) that processes multi-variable and multi-nodal inputs of robot actions into the commands that command the one or more robots.

15. The simulation-based CGF system in accordance with claim 12, wherein the commands are provided to different robot types that include wheeled robots and legged robots.

16. The simulation-based CGF system in accordance with claim 12, wherein the controller receives scenario plans from a remote system, disseminates tasks to the CGF module, and manages coordination between a plurality of the one or more robots for collaborative behaviours between the plurality of the one or more robots during training on the training field.

17. A method for conducting tactical training in a training field, comprising:
receiving information on the training field;
processing the information on the training field;
selecting a behaviour for each of one or more robots in the training field from a library of CGF behaviours stored in a database;
sending commands based on the selected behaviours to the one or more robots in the training field;
sensing, with one or more cameras and sensors located on the one or more robots, one or more trainees and movement of the one or more trainees during training on the training field; and
changing the selected behaviours of the one or more robots and difficulty levels for the trainees based on actions of the trainees detected by the one or more robots during the training on the training field;
wherein the information on the training field includes location of one or more trainees and the commands include shooting the one or more trainees.

18. The method in accordance with claim 17; wherein the computer vision algorithm comprises a model-based computer vision algorithm.

19. The method in accordance with claim 17, further comprising changing the selected behaviours of the one or more robots by slowing down movements of the one or more robots during the training to lower a difficulty level for the one or more trainees in the training.

20. The method in accordance with claim 17, wherein selecting the behaviour comprises selecting collaborative behaviour with other robots so that the one or more robots can conduct organizational behaviours.

21. The method in accordance with claim 17, wherein selecting the behaviour comprises selecting collaborative behaviour with one or more trainees so the one or more robots can conduct organizational behaviours with the one or more trainees.

22. The method in accordance with claim 17, wherein selecting the collaborative behaviour comprises communicating in audible voice output through a speaker system or through a radio communication system.

23. The method in accordance with claim 17, further comprising
engaging target using computer vision, the engaging comprising:
detecting a target;
tracking the detected target;
computing a positional difference between the tracked target and an alignment of a laser beam transmitter;
adjusting the alignment to match the tracked target; and
emitting a laser beam to the target from the laser beam transmitter.

24. The method in accordance with claim 23, further comprising receiving a feedback with regard to accuracy of the laser beam emission from the laser beam transmitter.

25. The method in accordance with claim 23, wherein the adjusting the alignment comprises rotating a platform of the laser beam transmitter.

26. The method in accordance with claim 23, wherein the computing comprising computing a positional difference of geo-location information in a geo-database.

27. The method in accordance with claim 23, wherein the detecting comprising range and depth sensing including any one of LIDAR and RADAR.
